(19) United States
(12) Patent Application Publication
(10) Pub. No.: US 2006/0290724 A1
(43) Pub. Date: Dec. 28, 2006

(54) Color element forming method, electro-optical device manufacturing method, electro-optical device, and electronic device

(75) Inventors: Nobuaki Nagae, Chino-shi (JP); Kazumi Aruga, Fujimi-machi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjyuku-ku (JP)

(21) Appl. No.: 11/454,780

(22) Filed: Jun. 19, 2006

(30) Foreign Application Priority Data
Jun. 23, 2005 (JP) JP 2005-182973
Apr. 3, 2006 (JP) JP 2006-101641

(51) Int. Cl. B41J 29/38

(52) U.S. Cl. 347/9

(57) ABSTRACT

A color element forming method includes providing a liquid droplet ejection apparatus having a moving section configured and arranged to relatively move a plurality of liquid droplet ejection heads with respect to a substrate in a state where the liquid droplet ejection heads and the substrate are disposed facing each other. The method further includes ejecting a plurality of types of liquids including color element materials from nozzles of the liquid droplet ejection heads in a drawing region of the substrate including a plurality of color element regions segmented by a plurality of partition wall portions in synchronization with main scanning conducted for a plurality of times by the moving section to draw a plurality of types of color elements in the color element regions of the substrate. The method further includes hypothetically dividing the drawing region of the substrate into a plurality of partial drawing regions.

### CROSS-REFERENCE TO RELATED APPLICATIONS

This application claims priority to Japanese Patent Application Nos. 2005-182973 and 2006-101641. The entire disclosures of Japanese Patent Application Nos. 2005-182973 and 2006-101641 are hereby incorporated herein by reference.

### BACKGROUND

1. Technical Field

The present invention relates to a color element forming method using a liquid droplet ejection apparatus, an electro-optical device manufacturing method, an electro-optical device, and an electronic device.

2. Related Art

As a liquid droplet ejection apparatus that ejects and draws a liquid including functional material as liquid droplets on a substrate, a drawing apparatus is known which uses inkjet heads of an inkjet printer as functional liquid droplet ejection heads (liquid droplet ejection heads). The drawing apparatus is provided with a moving section that causes the plurality of functional liquid droplet ejection heads to move in a main scanning direction and a sub-scanning direction via a carriage on which the plurality of functional liquid droplet ejection heads are mounted. Japanese Laid-Open Patent Publication No. 2004-267927 is an example of related art.

this drawing apparatus, the plurality of functional liquid droplet ejection heads are mounted on the carriage such that they are distributed in the sub-scanning direction in correspondence to a plurality of virtually divided sites on a workpiece (substrate) equally segmented in the sub-scanning direction. Further, the plurality of functional liquid droplet ejection heads conduct drawing by ejecting a liquid in parallel substantially simultaneously toward both outer side sections from an intermediate section in the sub-scanning direction with respect to the plurality of virtually divided sites. Thus, in comparison to when both outer side sections of the plurality of virtual divisional sites are drawn first, the drawing apparatus seeks to delay the period of time when solvent evaporates from the liquid that has landed at both outer side sites to reduce occurrences where the evaporation amount of the solvent before drying largely differs depending on the positions of the solvent on the substrate. That is, the drawing apparatus seeks to further reduce unevenness in the drying of film forming portions comprising the functional material after drying.

However, when the above-described conventional drawing apparatus is used to form a color filter including color elements (picture elements) of three colors, for example, one drawing apparatus that conducts drawing by ejecting a liquid including a color element material on a predetermined drawing region on the substrate is needed for each color, so that three drawing apparatuses are needed for the three colors. Further, the conventional drawing apparatus has the problem that, in addition to the amount of time required to supply the substrate to, position the substrate in, and remove the substrate from each drawing apparatus, the drawing apparatus requires time to draw all of the color elements because drying is conducted with a drying apparatus after drawing has been conducted with one drawing apparatus and before drawing is conducted with the next drawing apparatus.

In order to solve this problem, it is conceivable to draw all of the color elements inside the same drawing apparatus. However, drying during the drawing process is skipped, so that in a state where a plurality of types of liquids including different color element materials have landed on the substrate and risen due to surface tension, there has been the potential for different types of liquids to become mixed together and cause color mixing.

view of the above, it will be apparent to those skilled in the art from this disclosure that there exists a need for an improved color element forming method using a liquid droplet ejection apparatus, an improved electro-optical device manufacturing method, an improved electro-optical device, and an improved electronic device. This invention addresses this need in the art as well as other needs, which will become apparent to those skilled in the art from this disclosure.

### SUMMARY

It is an advantage of the present invention to provide a color element forming method that can conduct drawing by ejecting a plurality of types of liquids substantially simultaneously and in which it is difficult for color mixing to occur, a method of manufacturing an electro-optical device using this forming method, an electro-optical device, and an electronic device.

A color element forming method according to a first aspect of the invention uses a liquid droplet ejection apparatus having a plurality of liquid droplet ejection heads and moving section that causes the plurality of liquid droplet ejection heads and a substrate to be relatively moved in a state where the plurality of liquid droplet ejection heads and the substrate are disposed facing each other to eject. The liquid droplet ejection apparatus is configured and arranged to control the liquid droplet ejection heads and the moving section so that a plurality of types of liquids including color element materials are drawn to form a plurality of types of color elements in a drawing region including a plurality of color element regions segmented by partition wall portions disposed on the substrate in synchronization with main scanning conducted a plurality of times by the moving section. The method comprises performing a first drawing process to hypothetically or virtually dividing the drawing region into a plurality of partial drawing regions and drawing at least one partial drawing region by main-scanning, at least one time, the at least one partial drawing region. The method further comprising performing a second drawing process to redraw the at least one partial drawing region drawn in the first drawing process by repeating, at least one time, main scanning after a predetermined amount of time, wherein in one-time main scanning has elapsed since the first drawing process. The liquids are ejected and drawn in an ejection amount where a total amount of the liquids necessary in order to form the color element in one of the color element regions has been divided.

According to this method, in the first drawing process, a drawing region including a plurality of color element regions is hypothetically or virtually divided into a plurality of partial drawing regions, and at least one partial drawing region is drawn by main-scanning, at least one time, the at least one partial drawing region. Additionally, in the second drawing process, the at least one partial drawing region drawn in the first drawing process is drawn by repeating, at least one time, main scanning that redraws the at least one partial drawing region after a predetermined amount of time. Further, in one-time main scanning, the liquids are ejected and drawn in an ejection amount where a total amount of the liquids necessary in order to form the color element in one of the color element regions has been divided. Consequently, the plurality of types of liquids that have landed in the at least one partial drawing region drawn in the first drawing process spread in the color element regions and rise due to surface tension, but because the ejection amount is divided with respect to the necessary total amount, occurrences where the liquids including different color element materials rise over the partition wall portions segmenting the color element regions and become mixed are reduced. Further, in the second drawing process, because a predetermined amount of time is disposed until redrawing the same partial drawing region, the drying of the liquids ejected in the first drawing process proceeds and the liquids are film-reduced. Thus, even when main scanning is repeatedly conducted, the rising of the liquids is reduced and occurrences where the liquids including different color element materials become mixed together are reduced. That is, a color element forming method in which it is difficult for color mixing to occur, even when a plurality of types of liquids are ejected/drawn by the same liquid droplet ejection apparatus, can be provided.

Further, in the second drawing process, it is preferable for one of the divided regions resulting from the at least one partial drawing region being further hypothetically or virtually divided to be drawn by main scanning, and after a predetermined amount of time, for main scanning that draws the remaining divided region to be repeated and conducted at least one time.

According to this method, in the second drawing process, the at least one partial drawing region drawn in the first drawing process is further hypothetically or virtually divided, one of divided regions is drawn by main scanning after a predetermined amount of time, and then the remaining divided region is drawn after a predetermined amount of time. Consequently, in the remaining divided region, the liquids that landed in the first drawing process are again drawn in the second drawing process in a state where natural drying proceeds over a longer time. Therefore, even when the liquids are repeatedly caused to land in the remaining divided region where drying of the liquids has progressed, occurrences where the different types of liquids that have risen in the color element regions rise over the partition wall portions and become mixed are stochastically reduced. Thus, a color element forming method in which it is even more difficult for color mixing to occur, even when a plurality of types of liquids are ejected/drawn by the same liquid droplet ejection apparatus, can be provided.

Further, it is preferable for the method to further comprise the step of disposing the predetermined amount of time by drawing the other partial drawing regions other than the at least one partial drawing region between the first drawing process and the second drawing process by main scanning conducted at least one time.

According to this method, the drying of the liquids ejected in the first drawing process can be promoted during the step of disposing the predetermined amount of time to draw the other partial drawing region by main scanning conducted at least one time in comparison to when the second drawing process is implemented without disposing much time after the first drawing process. Thus, a color element forming method in which it is even more difficult for color mixing to occur can be provided.

Further, it is preferable for the method to further comprise the step of disposing the predetermined amount of time by drawing the other partial drawing regions other than the at least one partial drawing region between the first drawing process and the second drawing process by main scanning conducted at least two times.

According to this method, the second drawing process is conducted after implementing the step of disposing a longer predetermined amount of time to draw the other partial drawing region by main scanning conducted at least two times after the first drawing process. Thus, the drying of the liquids ejected in the first drawing process proceeds and the liquids are film-reduced, and a color element forming method in which it is even more difficult for color mixing to occur can be provided.

Further, it is preferable for the method to further comprise the step of disposing the predetermined amount of time by virtually dividing the drawing region into partial drawing regions of at least three divisions and drawing all of the other partial drawing regions other than one partial drawing region one time each between the first drawing process and the second drawing process.

According to this method, because the drawing region is hypothetically or virtually divided into partial drawing regions of at least three divisions, the second drawing process is conducted after all of the other partial drawing regions have been drawn one at a time, that is, after a predetermined amount of time to draw the other partial drawing regions by main scanning conducted at least two times. Consequently, the drying of the liquids ejected in the first drawing process proceeds and the liquids are film-reduced, and a color element forming method in which it is even more difficult for color mixing to occur can be provided.

Further, in the second drawing process, it is preferable for the liquids to be drawn such that the ejection amount of the liquids ejected by one-time main scanning is gradually reduced in comparison to the first drawing process.

According to this method, the capacity of each of the color element regions segmented by the partition wall portions is gradually reduced by the liquids that have landed and spread in the color element regions in comparison to when the liquids are ejected in an ejection amount where the total amount of the liquids necessary in order to form color elements in one color element region has been simply divided by the number of times main scanning is conducted, but because the amount of the liquids repeated ejected in the same color element regions becomes reduced, the rising of the liquids becomes reduced thereafter, and occurrences where the different types of liquids rise over the partition wall portions and become mixed together can be further reduced.

Further, in the first drawing process, it is preferable for the liquids to be ejected and drawn in the color element regions that are not adjacent to each other of the plurality of color element regions included in the at least one partial drawing region, and in the second drawing process, for the liquids to be ejected and drawn in the color element regions where the liquids were not ejected during the first drawing process.

According to this method, in the first drawing process, the liquids are ejected in color element regions that are not adjacent to each other, and in the second drawing process, the liquids are ejected such that the fill in the color element regions where the liquids were not ejected in the first drawing process. Thus, in the first drawing process, because the liquids are not ejected in the color element regions that are adjacent to each other, mixing together of the different types of liquids between adjacent color element regions is reduced. Further, the second drawing process is conducted after a predetermined amount of time, and the liquids are again ejected in a state where drying of the liquids ejected that were ejected in the first drawing process proceeds. Thus, occurrences where color mixing arises between adjacent color element regions can be further reduced.

Further, a plurality of liquid droplets may be caused to land and be drawn at intervals in the plurality of color element regions included in the at least one partial drawing region, and in the second drawing process, the liquids may be caused to land and be drawn in sites of the plurality of color element regions where the liquids did not land in the first drawing process.

According to this method, in the second drawing process, the liquids are caused to land and be drawn in the plurality of color element regions where the liquids did not land in the first drawing process. Consequently, because the liquids ejected in the second drawing process do not land on the liquids that were ejected in the first drawing process, rising of the landed liquids can be reduced. That is, occurrences where the risen liquids rise over the partition wall portions and become color-mixed with different types of liquids can be reduced.

An electro-optical device manufacturing method according to a second aspect of the invention is a method of manufacturing an electro-optical device provided with an electro-optical panel that includes a pair of substrates and a plurality of color element regions segmented by partition wall portions disposed on at least one of the substrates. The method comprises a color element drawing process of using the above-described color element forming method of the first aspect of the invention to draw a plurality of types of color elements by ejecting a plurality of types of liquids including color element materials in the plurality of color element regions on the substrate. The method further comprises a film forming process of drying the drawn color elements to form films.

According to this method, in the color element drawing process, a plurality of types of liquids are ejected in the plurality of element regions on the substrate and a plurality of types of color elements are drawn using a color element forming method in which it is difficult for color mixing to occur. Additionally, in the film forming step, the drawn color elements are dried to form films. Consequently, color unevenness and display unevenness resulting from color mixing are reduced, and an electro-optical device can be manufactured with good yield.

An electro-optical device according to a third aspect of the invention is an electro-optical device provided with an electro-optical panel that includes a pair of substrates and a plurality of color element regions segmented by partition wall portions disposed on at least one of the substrates, wherein a plurality of types of color elements are formed in the plurality of color element regions on the substrate using the above-described electro-optical device manufacturing method.

According to this configuration, because the plurality of types of color elements on the substrate of the electro-optical panel are manufactured using an electro-optical device manufacturing method in which it is difficult for color mixing to occur, an electro-optical device in which color unevenness and display unevenness resulting from color mixing are reduced and which has high display quality can be provided.

electronic device according to a fourth aspect of the present invention is provided with the above-described electro-optical device. According to this configuration, because the electronic device is provided with an electro-optical device in which color unevenness and display unevenness resulting from color mixing are reduced and which has high display quality, an electronic device with which information such as displayed images can be correctly confirmed can be provided.

Further, a liquid droplet ejection apparatus according to a fifth aspect of the invention is a liquid droplet ejection apparatus having a plurality of liquid droplet ejection heads and moving section that causes the plurality of liquid droplet ejection heads and a substrate to be relatively moved in a state where the plurality of liquid droplet ejection heads and the substrate are disposed facing each other. The liquid droplet ejection apparatus is configured and arranged to eject, in a drawing region including a plurality of color element regions segmented by partition wall portions disposed on the substrate, and in synchronization with main scanning conducted a plurality of times by the moving section, a plurality of types of liquids including color element materials from nozzles of the plurality of liquid droplet ejection heads to draw and form a plurality of types of color elements. The liquid droplet ejection apparatus comprises a drawing control section configured to control a first drawing process that hypothetically or virtually divides the drawing region into a plurality of partial drawing regions and draws at least one partial drawing region by main-scanning, at least one time, the at least one partial drawing region. The drawing control section is further configured to control a second drawing process that draws the at least one partial drawing region drawn in the first drawing by repeating, at least one time, main scanning that redraws the at least one partial drawing region after a predetermined amount of time has elapsed since the first drawing process. In one-time main scanning, the liquids are ejected and drawn in an ejection amount where a total amount of the liquids necessary in order to form the color element in one of the color element regions has been divided.

According to this configuration, in the first drawing process, a drawing region including a plurality of color element regions is virtually divided into a plurality of partial drawing regions, and at least one partial drawing region is drawn by main-scanning, at least one time, the at least one partial drawing region. Additionally, in the second drawing process, the at least one partial drawing region drawn in the first drawing process is drawn by repeating, at least one time, main scanning that redraws the at least one partial drawing region after a predetermined amount of time has elapsed after the first drawing process. Further, in one-time main scanning, the liquids are ejected and drawn in an ejection amount where a total amount of the liquids necessary in order to form the color element in one of the color element regions has been divided. Consequently, the plurality of types of liquids that have landed in the at least one partial drawing region drawn in the first drawing process spread in the color element regions and rise due to surface tension, but because the ejection amount is divided with respect to the necessary total amount, occurrences where the liquids including different color element materials rise over the partition wall portions segmenting the color element regions and become mixed are reduced. Further, in the second drawing process, because a predetermined amount of time is disposed until redrawing, the drying of the liquids ejected in the first drawing process proceeds and the liquids are film-reduced. Thus, even when main scanning is repeatedly conducted, the rising of the liquids is reduced and occurrences where the liquids including different color element materials become mixed together are reduced. That is, a liquid droplet ejection apparatus in which it is difficult for color mixing to occur, even when a plurality of types of liquids are ejected and drawn, can be provided.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a schematic perspective diagram showing the structure of a liquid droplet ejection apparatus;

FIG. 2A is a schematic perspective view of a liquid droplet ejection head;

FIG. 2B is a schematic plan view of the liquid droplet ejection head illustrating an arrangement of nozzles;

FIG. 3 includes a pair of schematic plan diagrams (a) and (b) showing carriages on which the liquid droplet ejection heads are mounted;

FIG. 4 is a block diagram showing the control system of the liquid droplet ejection apparatus;

FIG. 5 is a schematic perspective diagram showing the structure of a liquid crystal display device;

FIG. 6 is a flowchart showing a method of manufacturing the liquid crystal display device;

FIG. 7 includes a series of schematic cross-sectional diagrams (a) to (g) showing the method of manufacturing the liquid crystal display device;

FIG. 8 includes a pair of schematic diagrams (a) and (b) showing a method of drawing a drawing region on a substrate;

FIG. 9 includes a pair of schematic plan diagrams (a) and (b) showing ejected/drawn states of liquids in accordance with a first embodiment;

FIG. 10 includes a series of schematic plan diagrams (a) to (c) showing ejected/drawn states of liquids in accordance with a second embodiment;

FIG. 11 includes a series of schematic plan diagrams (a) to (d) showing ejected/drawn states of liquids in accordance with a third embodiment;

FIG. 12 includes a pair of schematic plan diagrams (a) and (b) showing ejected/drawn states of liquids in accordance with a fourth embodiment;

FIG. 13 is a schematic perspective diagram showing a portable information processing device serving as an electronic device; and

FIG. 14 includes a series of schematic diagrams (a) to (c) showing arrangements of color element regions.

### DESCRIPTION OF EXEMPLARY EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The embodiment of the present invention will be described by way of an example where a color element forming method uses a liquid droplet ejection apparatus that can eject a plurality of types of liquids including color element materials as liquid droplets to draw and form, on a plurality of color element regions of a substrate, color filters serving as color elements in a liquid crystal display panel of a liquid crystal display device serving as an electro-optical device.

### Liquid Droplet Ejection Apparatus

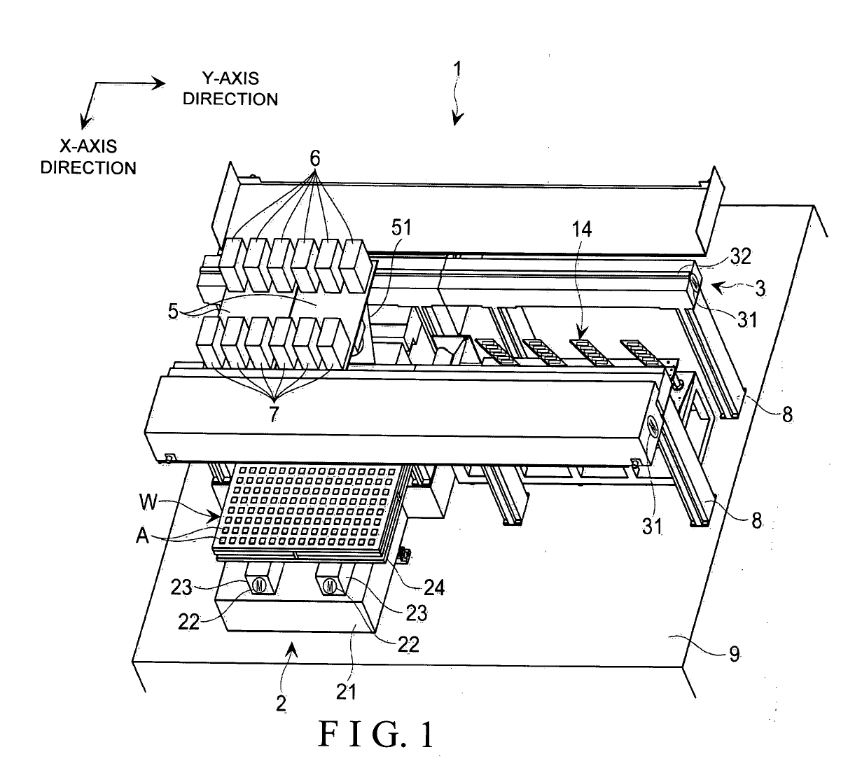

First, a liquid droplet ejection apparatus 1 will be described on the basis of FIGS. 1 to 3. FIG. 1 is a schematic perspective diagram showing the structure of the liquid droplet ejection apparatus 1.

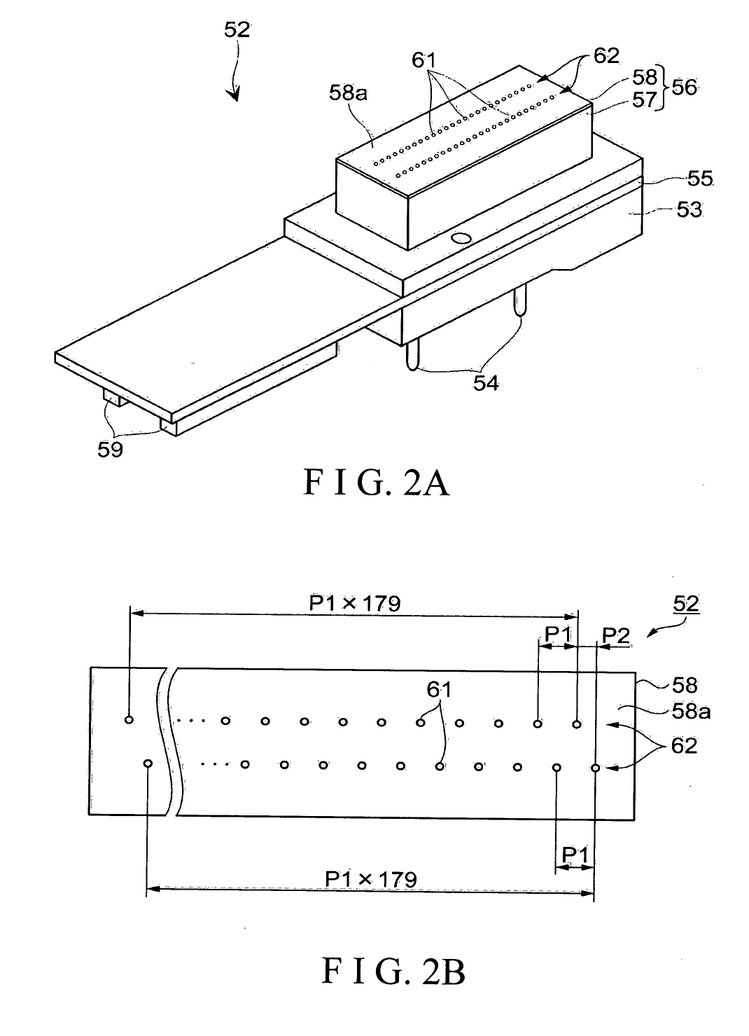

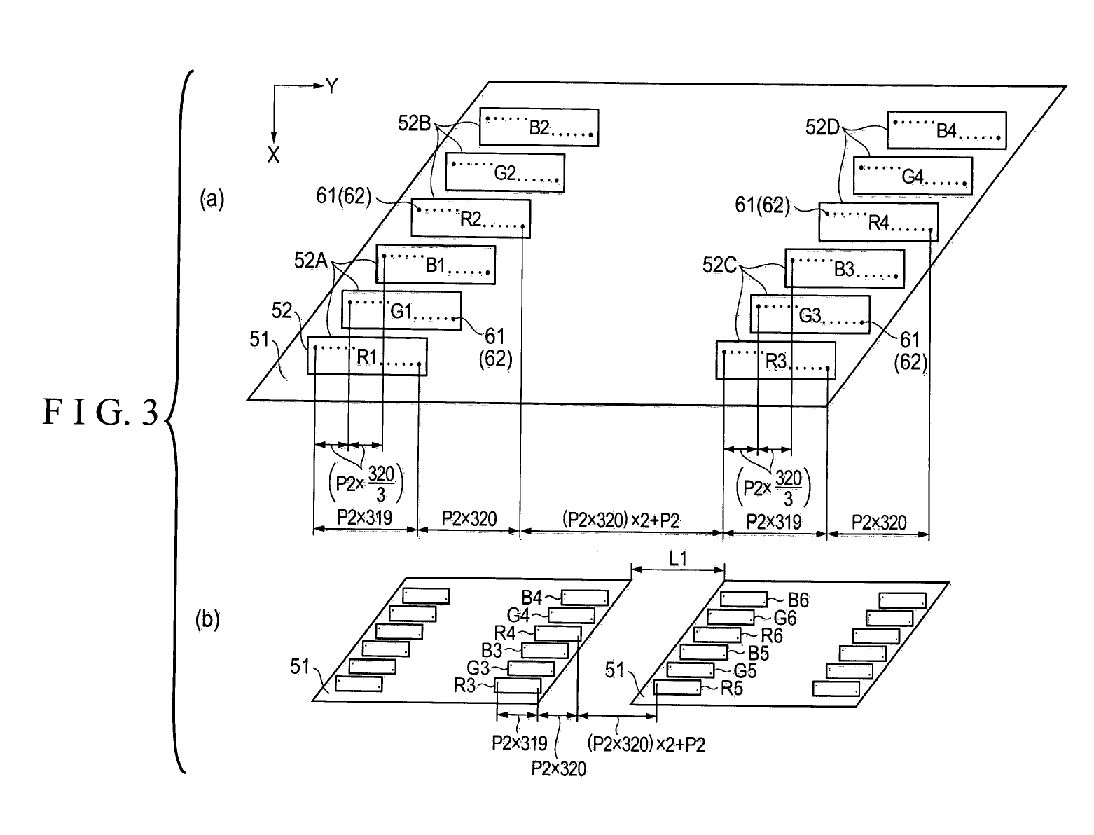

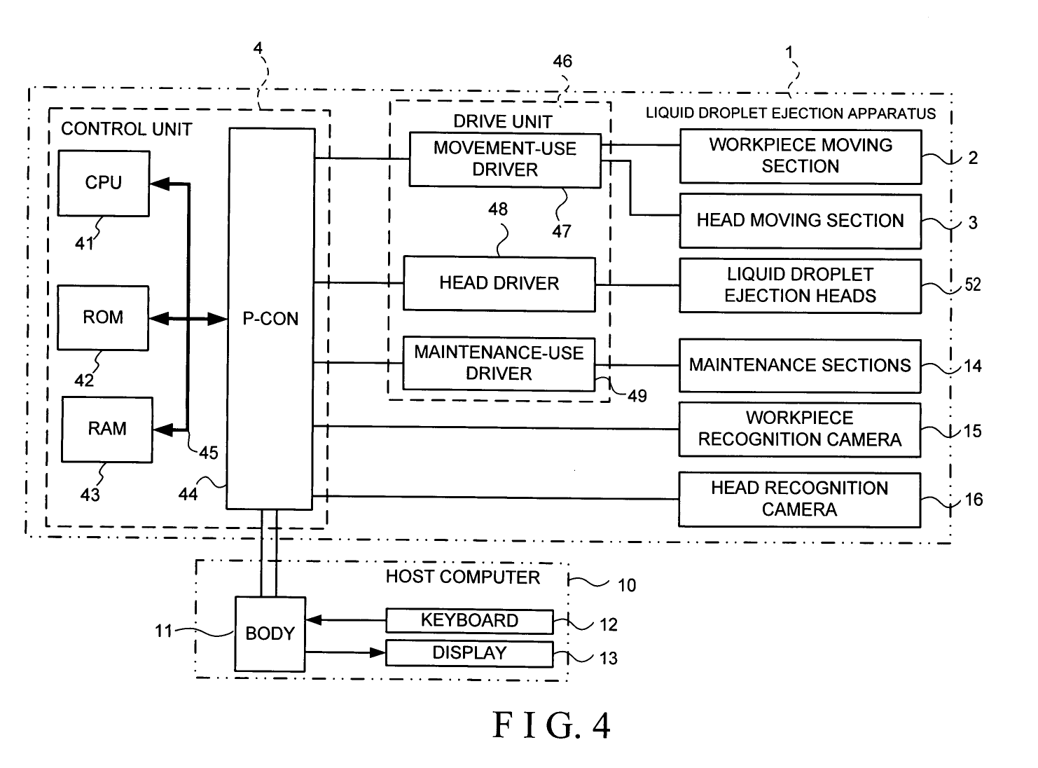

As shown in FIG. 1, the liquid droplet ejection apparatus 1 includes a workpiece moving section 2, on which a substrate W serving as a workpiece is placed and which causes the substrate W to move in an X-axis direction (main scanning direction), and a head moving section 3, which causes a plurality of carriage units 5 (e.g., two carriage units 5 are used in FIG. 1) to move in a Y-axis direction (sub-scanning direction). Each of the carriage units 5 is provided with a carriage 51 (see the diagrams (a) and (b) of FIG. 3) on which a plurality of liquid droplet ejection heads 52 (see FIGS. 2A and 2B) are mounted such that they face the substrate W. The liquid droplet ejection apparatus 1 is also provided with a control unit 4 (see FIG. 4) serving as a drawing control section that selectively drives the plurality of liquid droplet ejection heads 52 to cause them to eject a plurality of types of liquids onto the substrate W in synchronization with the moving of the substrate W in the X-axis direction by the workpiece moving section 2 (main scanning). The control unit 4 is configured to controls drawing conducted by virtually dividing a drawing region into a plurality of partial drawing regions and main-scanning, at least one time, at least one partial drawing region, and drawing conducted by repeating, at least one time, main scanning that redraws, after a predetermined amount of time, the at least one partial drawing region drawn at least one time.

The workpiece moving section 2 is provided with a set table 24, on which the substrate W is placed, and a pair of X-axis guide rails 23 provided with linear motors 22 that cause the set table 24 to move in the X-axis direction via air sliders (not shown). The pair of X-axis guide rails 23 are disposed on a stone surface plate 21 that is placed on a common frame 9 disposed on a floor and extend in the X-axis direction.

The set table 24 is provided with a suction table (not shown), on which the substrate W is vacuum-sucked and fixed, and a θ table (not shown), which can conduct horizontal adjustment and angle adjustment of the substrate W such that the surface of the substrate W precisely faces the plurality of liquid droplet ejection heads 52 across a predetermined interval.

The head moving section 3 includes a pair of Y-axis guide rails 32 provided with linear motors 31 that cause the plurality of carriage units 5 to move in the Y-axis direction via air sliders (not shown). The pair of Y-axis guide rails 32 are disposed such that they straddle the workpiece moving section 2 on eight support stands 8 standing on the common frame 9 at intervals.

A plurality of maintenance sections 14, which conduct maintenance such as eliminating clogs in the nozzles of the plurality of liquid droplet ejection heads 52 mounted on the carriage 51 and removing foreign matter and dirt from nozzle surfaces, are disposed between the pair of Y-axis guide rails 32 at positions facing the plurality of liquid droplet ejection heads 52.

The carriage units 5 are disposed such that they span the distance between the pair of Y-axis guide rails 32. The carriage units 5 include plates on which are placed liquid supply units 6, which store predetermined amounts of liquids fed thereto via pipes from tanks in which the liquids are stored and supply the liquids to the liquid droplet ejection heads 52, and head-use electrical units 7, which supply electrical signals for driving the liquid droplet ejection heads 52.

Next, the liquid droplet ejection heads 52 will be described referring to FIGS. 2A and 2B. FIGS. 2A and 2B are schematic diagrams showing the liquid droplet ejection head 52. FIG. 2A is a perspective diagram, and FIG. 2B is a plan diagram showing the disposition of nozzles.

As shown in FIG. 2A, the liquid droplet ejection head 52 of the present embodiment is a so-called twin head and is provided with a liquid feed-in portion 53 including twin connection pins 54, a head substrate 55 stacked on the feed-in portion 53, and a head body 56 that is disposed on the head substrate 55 and inside of which liquid in-head flow paths are formed. The connection pins 54 are connected to the liquid supply units 6 via pipes and supply the liquids to the in-head flow paths. Twin connectors 59, which are connected to the head-use electrical units 7 via a flexible flat table (not shown), are disposed on the head substrate 55.

The head body 56 includes a pressurizing portion 57, which includes cavities configured by piezo elements and the like, and a nozzle plate 58, which includes a nozzle surface 58a in which two nozzle rows 62 are formed parallel to each other.

As shown in FIG. 2B, each of the two nozzle rows 62 includes a plurality of nozzles 61 (e.g., 180 nozzles 61 are provided in this example) that are arranged at a pitch P1 and disposed in the nozzle plate 58 in a state where they are shifted a pitch P2 that is half the pitch P1. In this case, the pitch P1 is about 140 μm. Thus, 360 of the nozzles 61 are arranged at a nozzle pitch (P2) of about 70 μm when seen from a direction orthogonal to the nozzle rows 62. It will be noted that when the nozzles 61 actually eject the liquids, the ten nozzles 61 at both end sides of the nozzle rows 62 are not used. This is in consideration of the fact that it is difficult for the amounts of the liquids ejected from the nozzles 61 positioned at both end sides to be stable in comparison to the other nozzles 61. Consequently, the entire length of the effective nozzles of the liquid droplet ejection head 52 including the two nozzle rows 62 is the nozzle pitch P2×319 (about 22 mm).

In the liquid droplet ejection head 52, variations in the volumes of the cavities in the pressurizing portion 57 occur when drive waveforms in the form of electrical signals are applied to the piezo elements and the like from the head-use electrical units 7. The liquids filling the cavities are pressurized by the resulting pumping action, whereby the liquid droplet ejection head 52 can eject the liquids as liquid droplets from the nozzles 61. It will be noted that, although the liquid droplet ejection head 52 of the present embodiment includes two nozzle rows 62, the liquid droplet ejection head 52 is not limited to this arrangement and may also include one nozzle row 62. Further, the nozzle rows 62 discussed hereinafter refer to the rows of effective nozzles.

Next, the carriages 51 will be described referring to the diagrams (a) and (b) of FIG. 3. FIG. 3 includes the schematic plan diagrams (a) and (b) showing the carriages 51 on which the liquid droplet ejection heads 52 are mounted. Specifically, the diagrams (a) and (b) of FIG. 3 are plan diagrams facing the nozzle surfaces 58a.

As shown in the diagrams (a) and (b) of FIG. 3, each of the carriages 51 has the planar shape of a parallelogram. Four head groups 52A, 52B, 52C and 52D, each of which includes three liquid droplet ejection heads 52, are disposed in two groups each on each of the carriages 51 in the sub-scanning direction (Y-axis direction) and the main scanning direction (X-axis direction). Additionally, an interval is disposed in the sub-scanning direction between the two head groups 52A and 52B and the other two head groups 52C and 52D arranged in the main-scanning direction.

In the head group 52A, the three liquid droplet ejection heads 52 comprising a head R1, a head G1 and a head B1 that respectively eject different types of liquids (e.g. different colors) are disposed in parallel in the Y-axis direction. The positions of the end portions of the nozzle rows 62 of each of the liquid droplet ejection heads 52 are disposed such that they are mutually shifted in the Y-axis direction. The shift amount in this case is (the nozzle pitch P2×320)/3, that is, ⅓ of the sum of the entire length of the effective nozzles and one nozzle pitch. The disposition of the liquid droplet ejection heads 52 in the other head groups 52B, 52C and 52D is the same.

Moreover, the nozzle rows 62 of the liquid droplet ejection heads 52 that eject the same type of liquid between the head group 52A and the head group 52B (e.g., the head R1 and the head R2) are disposed such that they continue across one nozzle pitch when seen from the main scanning direction. Further, between the head group 52B and the head group 52C, the distance between the nozzle rows 62 of the liquid droplet ejection heads 52 that eject the same type of liquid and are positioned nearest each other when seen from the main scanning direction is set such that it is equal to a length where one nozzle pitch is added to the value of a natural number multiple of a value multiplying the number of head groups arranged in the main scanning direction (X-axis direction) by a length where one nozzle pitch is added to the entire length of the nozzle rows 62. That is, the distance between the nozzle rows 62 of the liquid droplet ejection heads 52 of the head R2 and the head R3, for example, is equal to the sum of one nozzle pitch (P2) and two times the result of one nozzle pitch (P2) being added to the entire length of the effective nozzles (P2×319), or in other words (P2×320)×2+P2.

Further, a distance L1 between the two carriages 51 is set such that, of the plurality of liquid droplet ejection heads 52 disposed on the different carriages 51, the distance between the nozzle rows 62 of the liquid droplet ejection heads 52 that eject the same type of liquid and are positioned nearest each other when seen from the main scanning direction is equal to a length where one nozzle pitch is added to the value of a natural number multiple of a value multiplying the number of head groups arranged in the main scanning direction (X-axis direction) by a length where one nozzle pitch is added to the entire length of the nozzle rows 62. For example, the distance L1 is set such that the distance between the nozzle rows 62 of the liquid droplet ejection heads 52 of the head R4 and the head R5 is equal to (P2×320)×2+P2.

By using the carriages 51 to repeatedly conduct main scanning in the X-axis direction and sub-scanning that causes the liquid droplet ejection heads 52 to be moved at intervals of (P2×320)×2+P2 in the Y-axis direction, it becomes possible to eject three different types of liquids in a drawing width that is continuous in the sub-scanning direction. The detailed method of ejection drawing will be described later.

Next, the control system of the liquid droplet ejection apparatus 1 will be described. FIG. 4 is a block diagram showing the control system of the liquid droplet ejection apparatus 1. As shown in FIG. 4, the control system of the liquid droplet ejection apparatus 1 is provided with a host computer 10 that includes a keyboard 12 and a display 13 connected to a body 11, a drive unit 46 that includes various types of drivers that drive the liquid droplet ejection heads 52, the workpiece moving section 2, the head moving section 3 and the maintenance sections 14, and the control unit 4 that is configured to control the entire liquid droplet ejection apparatus 1 including the drive unit 46.

The drive unit 46 is provided with a movement-use driver 47 that controls the driving of the linear motors 22 and 31 of the workpiece moving section 2 and the head moving section 3, a head driver 48 that controls the ejection of liquid droplets by, and the driving of, the liquid droplet ejection heads 52, and a maintenance-use driver 49 that controls the driving of maintenance-use units of the maintenance sections 14.

The control unit 4 is provided with a CPU 41, a ROM 42, a RAM 43 and a P-CON 44, which are all interconnected via a bus 45. The ROM 42 includes a control program region, which stores a control program and the like processed by the CPU 41, and a control data region, which stores control data and the like for conducting drawing and functional recovery.

The RAM 43 includes various types of storage units, such as a drawing data storage unit that stores drawing data for conducting drawing on the substrate W and a position data storage unit that stores position data of the substrate W and the liquid droplet ejection heads 52. The RAM 43 is used as various types of work regions for control processing. The various types of drivers in the drive unit 46, a workpiece recognition camera 15, and a head recognition camera 16 are connected to the P-CON 44, and logic circuits for supporting the functions of the CPU 41 and handling interface signals with peripheral circuits are configured and incorporated in the P-CON 44. For this reason, the P-CON 44 imports, to the bus 45, various types of commands from the host computer 10 as is or after processing the commands, and in conjunction with the CPU 41, the P-CON 44 outputs to the drive unit 46 data and control signals outputted to the bus 45 from the CPU 41 and the like as is or after processing the commands.

Additionally, the CPU 41 controls the entire liquid droplet ejection apparatus 1 by inputting various types of detection signals, various types of commands, and various types of data via the P-CON 44 in accordance with the control program in the ROM 42, processing various types of data and the like in the RAM 43, and outputting various types of control signals to the drive unit 46 and the like via the P-CON 44. For example, the CPU 41 conducts drawing by controlling the liquid droplet ejection heads 52, the workpiece moving section 2 and the head moving section 3 causing the liquids to be ejected from the nozzles 61 of the plurality of liquid droplet ejection heads 52 disposed facing the substrate W in synchronization with the relative movement (main scanning conducted a plurality of times) between the substrate W and the liquid droplet ejection heads 52 under predetermined drawing conditions and predetermined moving conditions. Further, the CPU 41 can vary the amounts of liquid droplets ejected from the nozzles 61 of the liquid droplet ejection heads 52 by one-time main scanning by selecting drive waveforms on the basis of control signals from the head driver 48.

### Liquid Crystal Display Device

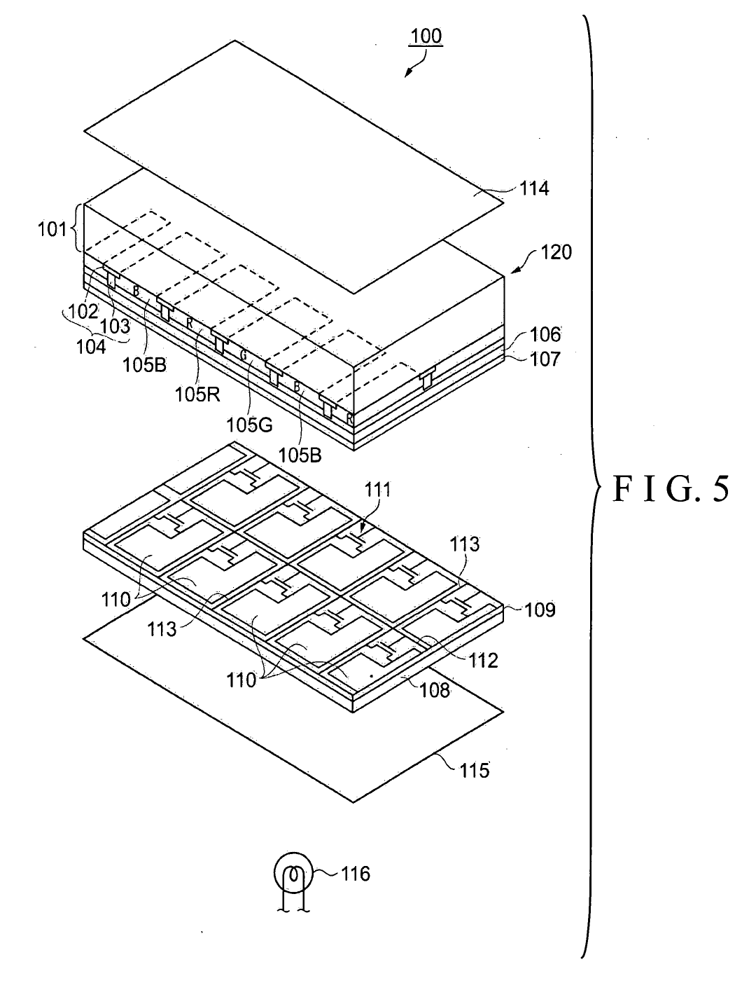

Next, a liquid crystal display device 100 serving as an electro-optical device of the present embodiment will be described referring to FIG. 5. FIG. 5 is a schematic perspective diagram showing the structure of the liquid crystal display device 100. As shown in FIG. 5, the liquid crystal display device 100 of the present embodiment is provided with a thin film transistor (TFT) transmissive-type liquid crystal display panel 120 and a lighting device 116 that lights the liquid crystal display panel 120. The liquid crystal display panel 120 is also provided with an opposing substrate 101 including color filters serving as color elements, an element substrate 108 including TFT elements 111, each of which includes three terminals with one of the three terminals being connected to pixel electrodes 110, and liquid crystal (not shown) sandwiched between the pair of the opposing substrate 101 and the element substrate 108. Further, an upper polarizing plate 114 and a lower polarizing plate 115 that cause transmitted light to be deflected are disposed on the surfaces of the pair of the opposing substrate 101 and the element substrate 108 that serve as the outer sides of the liquid crystal display panel 120.

The opposing substrate 101 comprises a material such as transparent glass. Color filters 105R, 105G and 105B of the three colors of red (R), green (G) and blue (B) are formed as a plurality of types of color elements in a plurality of color element regions segmented in a matrix by partition wall portions 104 on the surface of the opposing substrate 101 that sandwiches the liquid crystal between itself and the element substrate 108. The partition wall portions 104 are configured by lower banks 102 called a black matrix comprising a light-blocking metal such as Cr or an oxide film thereof and upper banks 103 comprising an organic compound formed on top of (in FIG. 5, facing downward) the lower banks 102. Further, the opposing substrate 101 is provided with an overcoat (OC) layer 106, which serves as a planarizing layer covering the partition wall portions 104 and the color filters 105R, 105G and 105B segmented by the partition wall portions 104, and an opposing electrode 107, which comprises a transparent conductive film such as indium tin oxide (ITO) formed such that it covers the OC layer 106. The color filters 105R, 105G and 105B are manufactured using a later-described liquid crystal display device manufacturing method.

The element substrate 108 similarly comprises a material such as transparent glass. The element substrate 108 includes the pixel electrodes 110, which are formed in a matrix via an insulating film 109 on the side of the element substrate 108 that sandwiches the liquid crystal between itself and the opposing substrate 101, and the plurality of TFT elements 111, which are formed in correspondence to the pixel electrodes 110. Of the three terminals of each of the TFT elements 111, the other two terminals not connected to the pixel electrodes 110 are connected to scan lines 112 and data lines 113, which are disposed in a grid such that they surround the pixel electrodes 110 in a state where they are mutually insulated.

The lighting device 116 may be any type of lighting device as long as it has a configuration such as a light guide plate, diffusion plate or reflection plate that uses a white LED, EL, or cold cathode tube, for example, as a light source and can emit light from these light sources toward the liquid crystal display panel 120.

will be noted that the active elements of the liquid crystal display panel 120 are not limited to TFT elements, and the liquid crystal display panel 120 may also include thin film diode (TFD) elements. Moreover, if the liquid crystal display panel 120 is one where color filters are disposed on at least one substrate, the liquid crystal display panel 120 may also be a passive type liquid crystal display where electrodes configuring pixels are disposed such that they intersect each other. Further, the upper polarizing plate 114 and the lower polarizing plate 115 may also be combined with an optically functional film such as phase difference film used for the purpose of improving viewing angle dependency.

### Method of Manufacturing Liquid Cristal Display Device

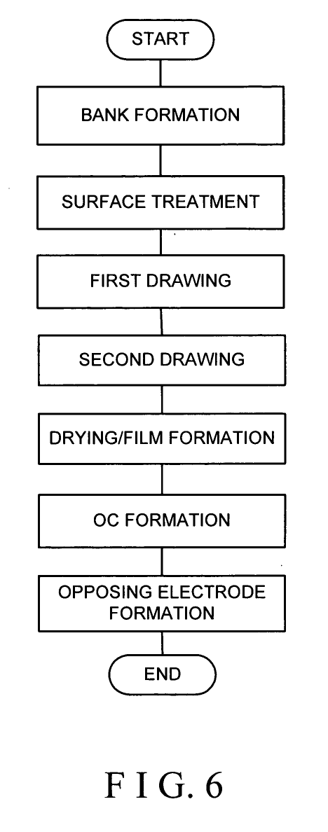

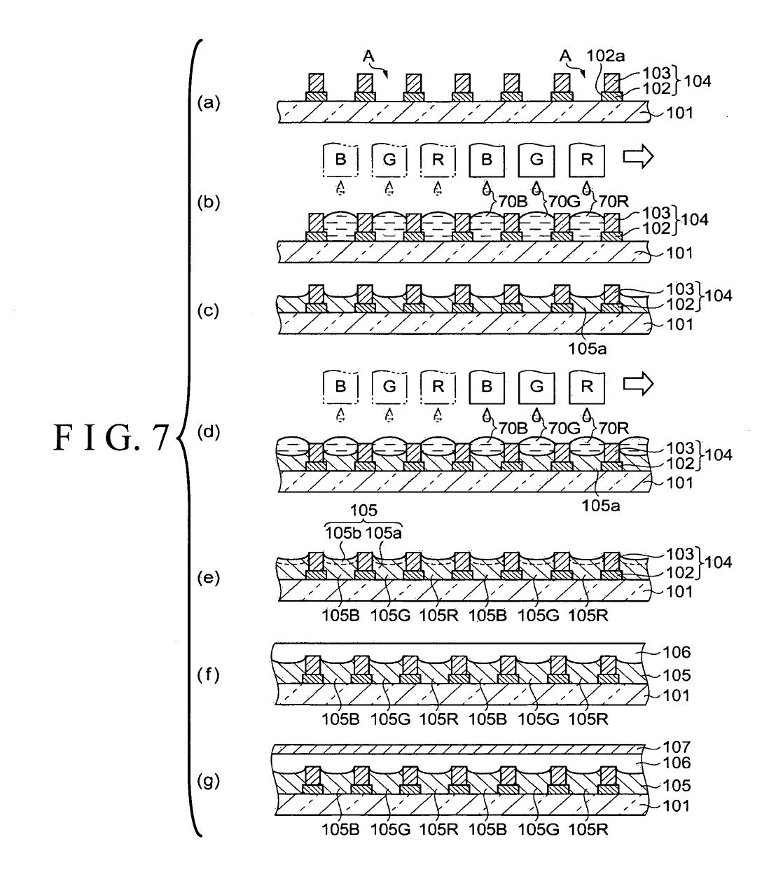

Next, the method of manufacturing the liquid crystal display device 100 using the color element forming method of the present invention will be described on the basis of FIGS. 6 to 12. FIG. 6 is a flowchart showing the method of manufacturing the liquid crystal display device 100. The diagrams (a) to (g) of FIG. 7 are schematic cross-sectional diagrams showing the method of manufacturing the liquid crystal display device 100.

As shown in FIG. 6, the method of manufacturing the liquid crystal display device 100 of the present embodiment includes the step of forming the partition wall portions 104 on the surface of the opposing substrate 101 and the step of surface-treating the color element regions segmented by the partition wall portions 104. The method also includes a first drawing process and a second drawing process, which serve as color element drawing processs that use the liquid droplet ejection apparatus 1 to apply three types (three colors) of liquids including color filter forming materials serving as color element forming materials to the surface-treated color element regions and draw the color filters 105, and a film forming step of drying the drawn color filters 105 to form films. The method also includes the step of forming the OC layer 106 such that it covers the partition wall portions 104 and the color filters 105 and the step of forming the transparent opposing electrode 107 such that it covers the OC layer 106.

When the liquid droplet ejection apparatus 1 is used to draw/form color elements, a motherboard designed such that an opposing substrate 101 corresponding to one liquid crystal display panel 120 is disposed in a matrix is used in the actual step of manufacturing the opposing substrate 101 of the liquid crystal display panel 120. Nowadays, motherboards are becoming ever larger in order to manufacture large-screen liquid crystal display panels 120 and to manufacture these efficiently and inexpensively. As a method of forming color filters serving as a plurality of types of color elements on a large motherboard, liquid droplet ejection is used in order to use color filter materials without waste and efficiently form color filters.

Step S1 of FIG. 6 is the step of forming the partition wall portions 104. In step S1, as shown in FIG. 7(a), first, the lower banks 102 serving as a black matrix are formed on the opposing substrate 101. An opaque metal such as Cr, Ni, or Al, for example, or a compound such as oxides of these metals, can be used as the material of the lower banks 102. The lower banks 102 are formed by applying a film comprising the above-described material, by vapor deposition or sputtering, to the opposing substrate 101. The film thickness may be set in accordance with a material whose film thickness has been selected to ensure a light-shielding property. For example, if the material comprises Cr, then it is preferable for the film thickness to be 100 to 200 nm. Then, portions of the film other than portions corresponding to open portions 102a are covered with a resist by photolithography, and the film is etched using an etching liquid corresponding to the above-described material, such as acid. Thus, the lower banks 102 including the open portions 102a are formed.

Next, the upper banks 103 are formed on top of the lower banks 102. An acryl photosensitive resin material can be used as the material of the upper banks 103. Further, it is preferable for the photosensitive resin material to have a light-shielding property. The upper banks 103 are formed by applying the photosensitive resin material, by roll coating or sputtering, to the surface of the opposing substrate 101 on which the lower banks 102 have been formed, and drying the photosensitive resin material to form a photosensitive resin layer whose thickness is about 2 μm. The upper banks 103 may also be formed by causing a mask that has a size corresponding to color element regions A and in which open portions are disposed to face the opposing substrate 101 at a predetermined position and exposing/developing the mask. Thus, the partition wall portions 104, which segment the plurality of color element regions A in a matrix, are formed on the opposing substrate 101. Then, the method proceeds to step S2.

Step S2 in FIG. 6 is the surface treatment step. In step S2, plasma treatment using 02 as a treatment gas and plasma treatment using fluorine gas as a treatment gas are conducted. That is, the color element regions A are treated such that they become liquid-attracting, and then the surfaces (including the wall surfaces) of the upper banks 103 comprising the photosensitive resin are treated such that they become liquid-repellent. Then, the method proceeds to step S3.

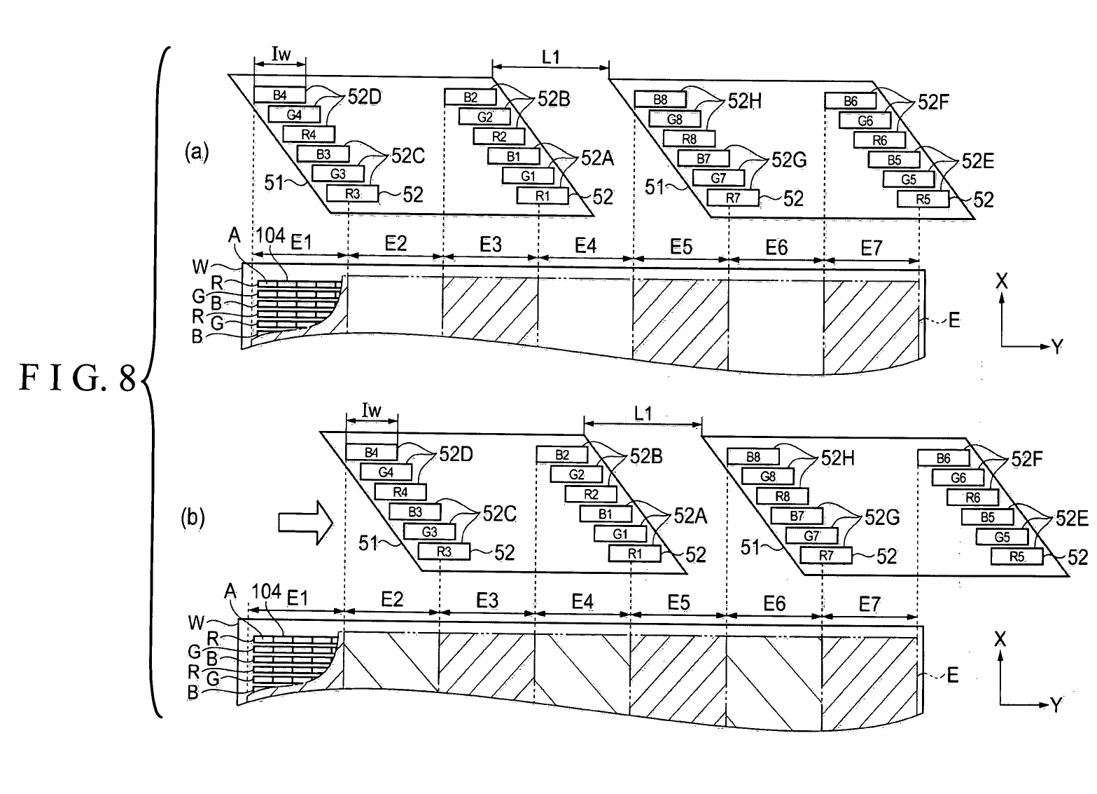

The method of drawing a drawing region E on the substrate W serving as a motherboard actually used here will be described referring to the diagrams (a) and (b) of FIG. 8. The diagrams (a) and (b) of FIG. 8 are schematic diagrams showing the method of drawing the drawing region E on the substrate W. Specifically, the diagrams (a) and (b) of FIG. 8 are schematic diagrams based on a state where the nozzles surfaces 58a of the liquid droplet ejection heads 52 mounted on the carriages 51 are disposed such that they face the substrate W. The width, in the Y-axis direction, of each of the quadrangles representing the liquid droplet ejection heads 52 beginning with head R1, head G1 and head B1 that eject different types of liquids in the diagrams (a) and (b) of FIG. 8 is represented by a drawing width Iw that corresponds to the entire length of the effective nozzles of the liquid droplet ejection heads 52. Further, the sizes of the color element regions A and the head groups 52A to 52H are depicted as being enlarged or reduced to an appropriate size in order to facilitate description.

As shown in the diagrams (a) and (b) of FIG. 8, the plurality of color element regions A are segmented by the partition wall portions 104 in the drawing region E on the substrate W serving as a motherboard such that the same type of color elements are arranged in the Y-axis direction. The color element regions A are also segmented such that different types of color elements are arranged in the order of red, green, and blue in the X-axis direction. Thus, disposition of the color element regions A is striped.

The carriages 51 are disposed such that two carriages 51 are lined in the Y-axis direction with respect to the substrate W. Color filters of a plurality of colors can be drawn by selectively ejecting a plurality of types of liquids into the plurality of color element regions A from the nozzles 61 of the liquid droplet ejection heads 52 in synchronization with the moving of the substrate W in the X-axis direction by the workpiece moving section 2 of the previously described liquid droplet ejection apparatus 1, that is, main scanning.

As shown in the diagram (a) of FIG. 8, the drawing region E on the substrate W is hypothetically or virtually divided into seven partial drawing regions E1 to E7. The width of each of the partial drawing regions E1 to E7 is equal to the length (P2×319)×2+P2 of the portion where the nozzle rows 62 of the liquid droplet ejection heads 52 that are mounted on the carriages 51 and eject the same type of liquid are continuous when seen from the main scanning direction, that is, equal to a length where one nozzle pitch is added to two times the drawing width Iw corresponding to the entire length of the effective nozzles of the liquid droplet ejection heads 52. For example, by positioning the carriages 51 with respect to the substrate W and conducting main scanning such that the end of the effective nozzles of the head B4 that ejects liquid including color filter material of blue (B) is positioned at substantially the same position as the end of the drawing region E in the Y-axis direction, the liquid including the color filter material of blue can be ejected everywhere with respect to the color element regions A of blue arranged in the four partial drawing regions E1, E3, E5 and E7.

In this case, the positions of the end portions of the nozzle rows 62 of the liquid droplet ejection heads 52 that are loaded in the carriages 51 and eject different types of liquids are disposed such that they are mutually shifted. Consequently, when other types of liquids are simultaneously ejected, portions arise where the liquids corresponding to the color element regions A of green (G) and red (R) are not ejected in the Y-axis direction in the four partial drawing regions E1, E3, E5 and E7. Thus, by conducting main scanning after the carriages 51 have been sub-scanned in the Y-axis direction at a length corresponding to the shift amount of the end portions of the nozzle rows 62, different types of liquids can be ejected everywhere with respect to the three types (red, green, and blue) of the color element regions A arranged in the four partial drawing regions E1, E3, E5 and E7. It will be noted that, in this case, the liquids can be similarly ejected everywhere even if the carriages 51 are sub-scanned at two times the length corresponding to the shift amount of the end portions of the nozzle rows 62, and the number of times that sub-scanning is conducted can be reduced.

shown in FIG. 8(b), when the other partial drawing regions E2, E4 and E6 are to be drawn, the carriages 51 are moved (line fed) a length where one nozzle pitch is added to two times the drawing width Iw corresponding to the entire length of the effective nozzles in the Y-axis direction, that is, a length corresponding to (P2×319)×2+P2. Then, by conducting main scanning in the X-axis direction, different types of liquids can be ejected into the corresponding color element regions A across the entire drawing region E. In this case also, by repeating main scanning after conducting sub-scanning corresponding to the shift amount of each of the nozzle rows 62, different types of liquids can be ejected everywhere with respect to the three types (red, green, and blue) of the color element regions A arranged in the other partial drawing regions E2, E4 and E6.

In the present embodiment, description has been given on the assumption that the drawing region E on the substrate W is virtually divided equally into the seven partial drawing regions E1 to E7, but the present embodiment is not limited to this. It is alright if excess regions arise as a result of virtually dividing the drawing region E in accordance with the size of the substrate W. For example, the embodiment can also accommodate a case where the width of the partial drawing region E7 is narrower than those of the other partial drawing regions E1 to E6. Further, when the size of the substrate W is larger than when two of the carriages 51 are provided with an interval L1 therebetween, the embodiment can accommodate this by further conducting line feeding or disposing more of the carriages 51.

Step S3 of FIG. 6 will be described based on the basic drawing method described above. Step S3 is the first drawing process of color filters serving as color elements. In step S3, as shown in the diagram (b) of FIG. 7, color filters 105 are drawn by applying corresponding liquids 70R, 70G and 70B to the surface-treated color element regions A. The liquid 70R includes a red (R) color filter forming material, the liquid 70G includes a green (G) color filter forming material, and the liquid 70B includes a blue (B) color filter forming material. Then, using the liquid droplet ejection apparatus 1, the liquid droplet ejection heads 52 are filled with the liquids 70R, 70G and 70B, and the liquids 70R, 70G and 70B are caused to land in the color element regions A as liquid droplets. In the first drawing process, as shown in the diagram (a) of FIG. 8, one-time main scanning using the end portion of the head B4 as a reference and sub-scanning and main scanning corresponding to the shift amount of the nozzle rows 62 are repeated at least one time, whereby the four partial drawing regions E1, E3, E5 and E7 are ejection-drawn. Next, as shown in the diagram (b) of FIG. 8, the carriages 51 are line-fed, and one-time main scanning using the end portion of the head B4 as a reference and sub-scanning and main scanning corresponding to the shift amount of the nozzle rows 62 are repeated at least one time, whereby the remaining partial drawing regions E2, E4 and E6 are ejection-drawn. The ejection amount of the liquid ejected in one color element region A in this case is reduced by dividing the total amount of the necessary liquid. Consequently, the different types of liquids 70R, 70G and 70B that have landed spread in the color element regions A and rise due to surface tension, but because the ejection amount is reduced with respect to the necessary total amount, occurrences where the liquids rise over the partition wall portions 104 and become mixed are suppressed.

Further, with respect to the liquids 70R, 70G and 70B that have landed in the color element regions A of the partial drawing regions E1, E3, E5 and E7 that were previously ejection-drawn, the step of disposing a predetermined amount of time to ejection-draw the remaining partial drawing regions E2, E4 and E6 is disposed, whereby the solvent portions evaporate and natural drying proceeds to form a film-reduced first drawing layer 105a, as shown in the diagram (c) of FIG. 7. It will be noted that, with respect to the remaining partial drawing regions E2, E4 and E6 also, because the step of disposing a predetermined amount of time in which the four partial drawing regions E1, E3, E5 and E7 are redrawn is implemented until redrawing in a second drawing process described below, the liquids 70R, 70G and 70B that have been ejected in the first drawing process become the film-reduced first drawing layer 105a, as shown in the diagram (c) of FIG. 7. Then, the method proceeds to step S4.

Step S4 in FIG. 6 is the second drawing process. In step S4, first, the four partial drawing regions E1, E3, E5 and E7 are redrawn. Next, the remaining partial drawing regions E2, E4 and E6 are redrawn. The method of drawing the partial drawing regions E1 to E7 in this case is basically the same as in the first drawing process of step S3, but the ejection amount of the liquid ejected by one-time main scanning into one color element region A at the time of redrawing is gradually reduced in comparison to the previous first drawing process. Consequently, as shown in the diagram (d) of FIG. 7, even if the liquids 70R, 70G and 70B are ejected onto the first drawing layer 105a, occurrences where the liquids 70R, 70G and 70B that have risen due to surface tension rise over the partition wall portions 104 and become mixed are suppressed because the ejection amount is reduced. Then, the method proceeds to step S5. It will be noted that a more detailed color element forming method in the first drawing process and the second drawing process will be described later.

Step S5 in FIG. 6 is the step of drying the drawn color filters 105 to form films. In step S5, as shown in the diagram (e) of FIG. 7, the drawn color filters 105 are dried at once such that a second drawing layer 105b becomes layered on the first drawing layer 105a, and the solvent portions are removed from the liquids 70R, 70G and 70B, whereby films of the color filters 105R, 105G and 105B are formed. It is preferable for the color filters 105 to be dried using a method as reduced-pressure drying that can homogenously dry the solvent portions. Then, the method proceeds to step S6.

Step S6 in FIG. 6 is the OC layer forming step. In step S6, as shown in the diagram (f) of FIG. 7, the OC layer 106 is formed such that it covers the color filters 105 and the upper banks 103. A transparent acryl resin material can be used as the material of the OC layer 106. Examples of the forming method include spin-coating and offset printing. The OC layer 106 is disposed in order to alleviate unevenness in the surface of the opposing substrate 101 in which the color filters 105 are formed and to planarize the opposing electrode 107 that is thereafter disposed on the surface of the OC layer 106. Further, a thin film of SiO₂ or the like may be further formed on top of the OC layer 106 in order to ensure adhesion with the opposing electrode 107. Then, the method proceeds to step S7.

Step S7 in FIG. 6 is the step of forming the opposing electrode 107. In step S7, as shown in FIG. 7(g), sputtering or vapor deposition is used to form a film of a transparent electrode material such as ITO in a vacuum, whereby the opposing electrode 107 is formed on the entire surface such that it covers the OC layer 106.

In the liquid crystal display device manufacturing method described above, attention was paid to the four partial drawing regions E1, E3, E5 and E7, but paying attention to the remaining partial drawing regions E2, E4 and E6, the first drawing process and the second drawing process are similarly disposed, and after the first drawing process, the second drawing process is conducted after disposing a predetermined amount of time to draw the four partial drawing regions E1, E3, E5 and E7.

In the present embodiment, the color filters 105 were formed such that the second drawing layer 105b was layered on the first drawing layer 105a, but the present invention is not limited to this and may also be configured such that a plurality of drawing layers are layered.

Further, an example was described where the partition wall portions 104 were formed by the lower banks 102 and the upper banks 103, but the present invention is not limited to this and may also be configured such that the partition wall portions 104 are formed by single-layer banks using a material having a light-shielding property.

By using the liquid crystal display device manufacturing method described above to form the color filters 105 serving as color elements on the opposing substrate 101, color mixing defects in the color filters 105 can be reduced and the opposing substrate 101 can be manufactured with good yield. Further, by using an adhesive to adhere, at predetermined positions, the finished opposing substrate 101 and the element substrate 108 including the pixel electrodes 110 and the TFT elements 111, and by filling the space between the pair of the opposing substrate 101 and the element substrate 108 with liquid crystal, the liquid crystal display device 100, in which color mixing of the color filters 105 is reduced and which has display quality that is highly attractive, is finished.

Next, the ejection-drawing of the liquids in the first drawing process and the second drawing process serving as the color element forming method in the method of manufacturing the liquid crystal display device 100 will be described in greater detail on the basis of a first embodiment to a fourth embodiment.

### First Embodiment

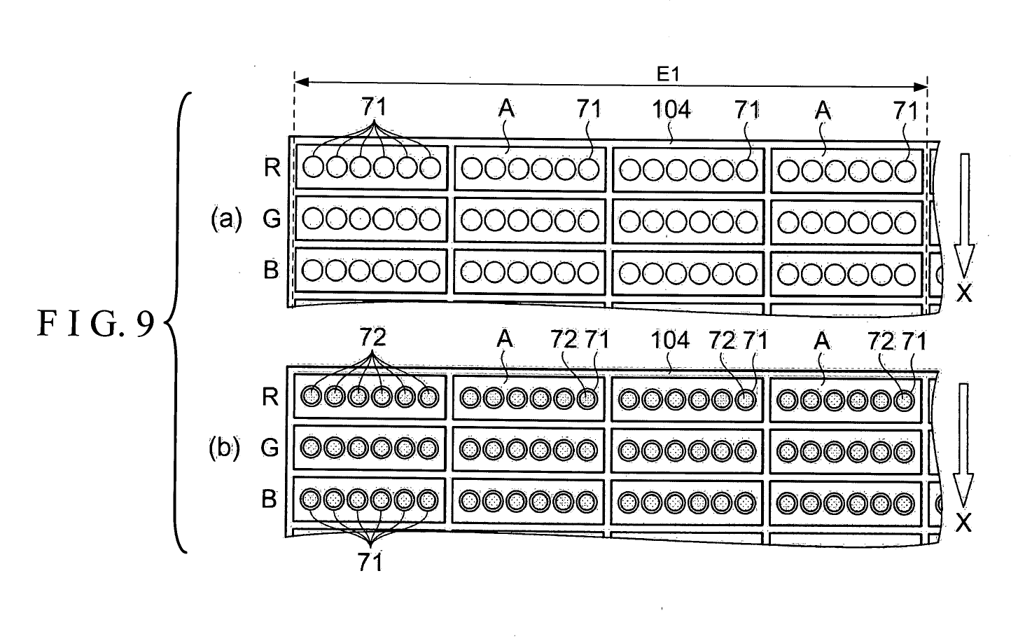

The diagrams (a) and (b) of FIG. 9 are schematic plan diagrams showing the ejected/drawn state of the liquids in the first embodiment. Specifically, the diagram (a) of FIG. 9 shows the landed state of the liquids in the first drawing process, and the diagram (b) of FIG. 9 shows the landed state of the liquids in the second drawing process.

As shown in the diagram (a) of FIG. 9, in the first drawing process, the different types of liquids 70R, 70G and 70B are ejected/drawn as liquid droplets, by main scanning conducted at least two times, in the plurality of color element regions A of the four partial drawing regions E1, E3, ES and E7 (only the partial drawing region E1 is shown in FIG. 9) previously shown in the diagrams (a) and (b) of FIG. 8. The ejection amount of liquid 71 that has landed in the color element regions A is an amount where the total amount necessary in order to form a color element in one color element region A is reduced. Then, after implementing the step of disposing a predetermined amount of time to similarly eject/draw the remaining partial drawing regions E2, E4 and E6 shown in the diagrams (a) and (b) of FIG. 8, the four partial drawing regions E1, E3, ES and E7 are re-ejected or redrawn. The ejection amount of liquid 72 that has landed in the color element regions A this time is reduced in comparison to the ejection amount of the liquid 71 in consideration of the fact that there is a remaining amount of the liquid 71 that has landed previously. Consequently, because the liquid 72 lands after the liquid 71 that has previously landed spreads in the color element regions A, naturally dries and is film-reduced after the predetermined amount of time, occurrences where the different types of liquids 70R, 70G and 70B rise over the partition wall portions 104 and become mixed together such that color mixing occurs are reduced in comparison to when the necessary total amount is all ejected in the first drawing process.

### Second Embodiment

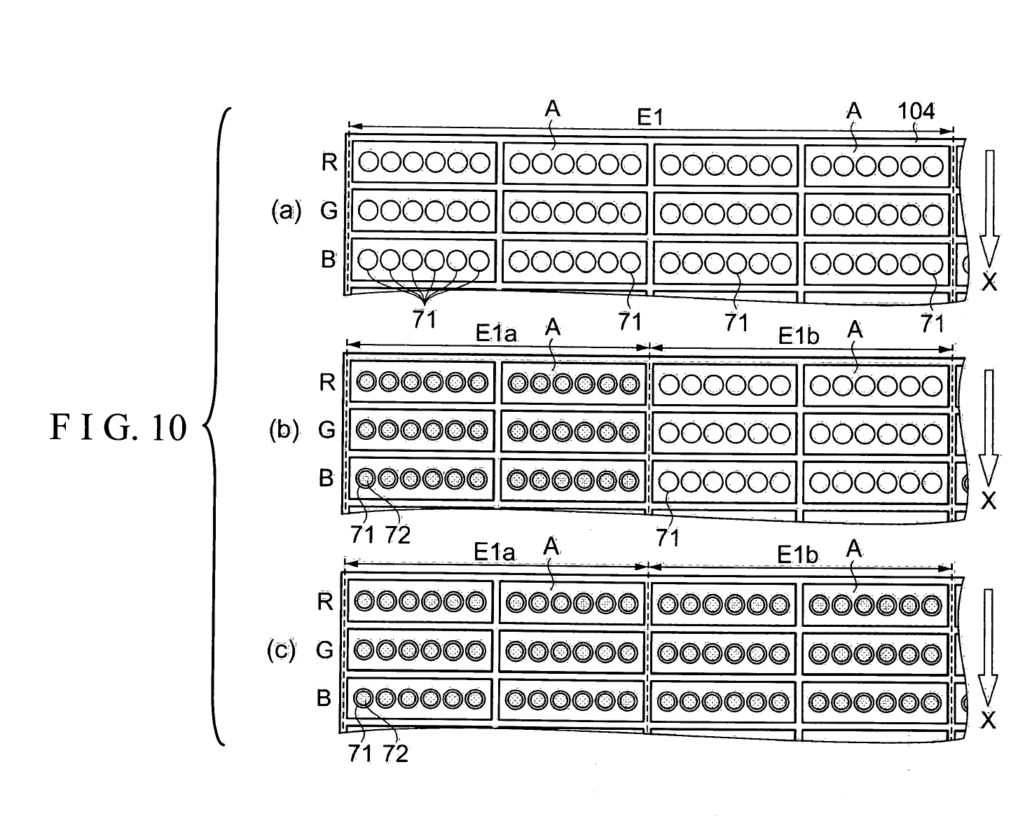

The diagrams (a) to (c) of FIG. 10 are schematic plan diagrams showing the ejected/drawn state of liquid in the second embodiment. Specifically, the diagram (a) of FIG. 10 shows the landed state of the liquids in the first drawing process, and the diagrams (b) and (c) of FIG. 10 show the landed state of the liquids in the second drawing process. The second embodiment is one where, with respect to the first embodiment, in the second drawing process, one of divided regions resulting from the partial drawing regions being further virtually divided, is drawn by main scanning, and after a predetermined amount of time, main scanning that draws the remaining divided region is repeated at least one time.

As shown in the diagram (a) of FIG. 10, in the first drawing process, similar to the first embodiment, first, the drawing region E shown in the diagrams (a) and (b) of FIG. 8 is divided into the four partial drawing regions E1, E3, E5 and E7 (only the partial drawing region E1 is shown in FIG. 10) and the remaining partial drawing regions E2, E4 and E6, and main scanning is repeated, whereby the drawing regions are drawn. Then, after a predetermined amount of time to ejection-draw the remaining partial drawing regions E2, E4 and E6, the second drawing process is conducted which redraws the drawing region E. At this time, as shown in the diagram (b) of FIG. 10, the partial drawing region E1, for example, is virtually divided into two divided regions (sub regions) E1a and E1b, and first the divided region E1a is redrawn. The ejection amount of the landed liquids 71 and 72 is gradually reduced in the same manner as in the first embodiment. With respect to the other three partial drawing regions E3, E5 and E7, one divided region resulting from each of these drawing regions being similarly further virtually divided into two is redrawn. Then, line feeding (sub-scanning) is conducted, and with respect to the remaining partial drawing regions E2, E4 and E6, one divided region resulting from each of these drawing regions being similarly virtually divided into two is redrawn. Next, as shown in the diagram (c) of FIG. 10, a predetermined amount of time is disposed to redraw one divided region of each of the remaining partial drawing regions E2, E4 and E6, and this time, the remaining divided region E1b of the four partial drawing regions E1, E3, E5 and E7 is redrawn one after the other. In so doing, a long time becomes necessary in comparison to the first embodiment until the remaining divided regions are redrawn. Thus, natural drying of the liquid 71 that has landed in the remaining divided regions proceeds, the liquid 71 becomes further film-reduced, and the next liquid 72 lands thereafter, so that color mixing is further reduced.

### Third Embodiment

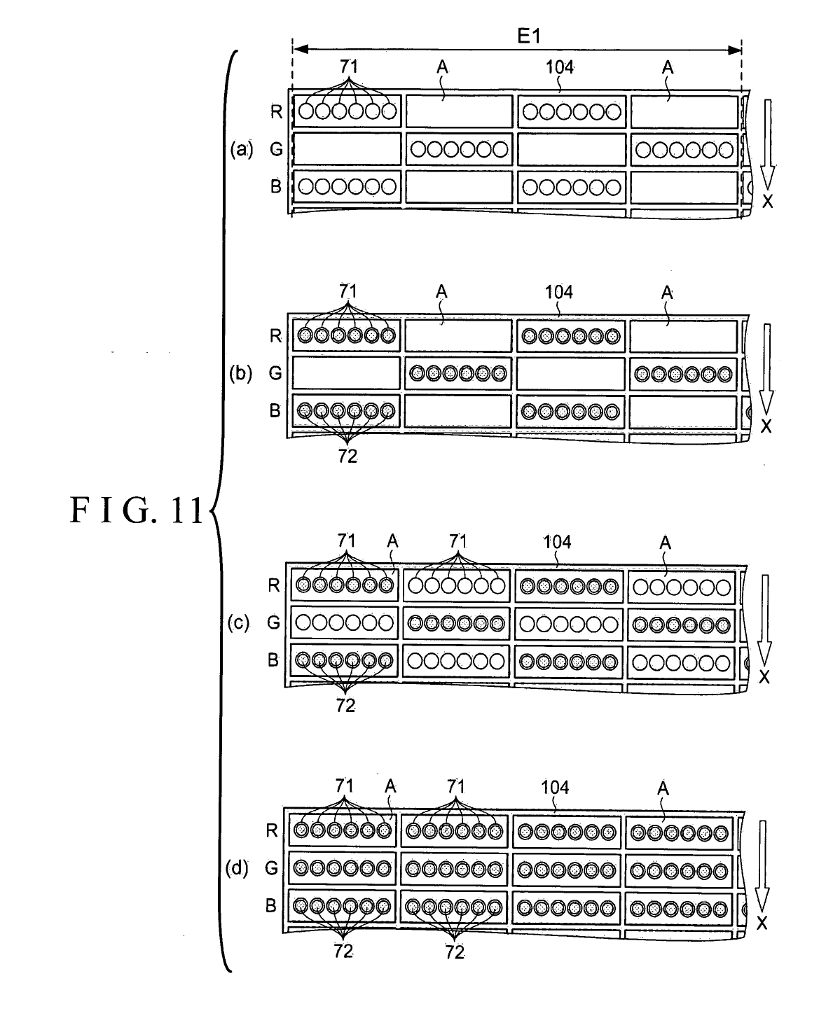

The diagrams (a) to (d) of FIG. 11 are schematic plan diagrams showing the ejected/drawn state of the liquids of the third embodiment. Specifically, the diagrams (a) and (b) of FIG. 11 show the ejected/drawn states in the first drawing process, and the diagrams (c) and (d) of FIG. 11 show the ejected/drawn states in the second drawing process. The third embodiment is one where, in the first drawing process, of the plurality of color element regions A included in the drawing region E, the liquids are ejected and drawn in the color element regions A that are not adjacent to each other, and in the second drawing process, the liquids are ejected and drawn in the color element regions A where the liquids were not ejected in the first drawing process.

shown in the diagram (a) of FIG. 11, in the first drawing process, first, the liquid 71 whose total amount to be ejected has been divided is caused to land in the color element regions A that are not adjacent to each other of the plurality of color element regions A where the three types of color elements, red, green and blue of the drawing region E are to be formed. Then, as shown in the diagram (b) of FIG. 11, the liquid 72 whose ejection amount has been reduced is caused to land. At this time, as shown in the diagrams (a) and (b) of FIG. 8, the drawing region E is divided into the four partial drawing regions E1, E3, E5 and E7 and the remaining partial drawing regions E2, E4 and E6, and main scanning is repeated, whereby the liquids 71 and 72 are ejected and drawn. Next, as shown in the diagram (c) of FIG. 11, in the second drawing process, the liquid 71 is caused to land in the color element regions A where the liquids 71 and 72 were not ejected. Then, as shown in the diagram (d) of FIG. 11, the liquid 72 whose ejection amount has been reduced is caused to land. In the method of ejecting/drawing the liquids 71 and 72, similar to the first drawing process, the drawing region E is divided into the four partial drawing regions E1, E3, E5 and E7 and the remaining partial drawing regions E2, E4 and E6, and main scanning is repeated. In so doing, the liquids 71 and 72 land in one of the adjacent color element regions A. Then, the liquid 72 is ejected in the four partial drawing regions E1, E3, E5 and E7 after a predetermined amount of time to eject/draw the liquid 71 in the remaining partial drawing regions E2, E4 and E6. Further, in the remaining partial drawing regions E2, E4 and E6, the liquid 72 is ejected after a predetermined amount of time in which the liquid 72 is ejected in the four partial drawing regions E1, E3, E5 and E7. Thus, in one-time main scanning, the liquids 71 and 72 do not land in adjacent color element regions A, but rather the liquid 72 lands after natural drying of the previously ejected liquid 71 proceeds and the liquid 71 becomes film-reduced as a result of disposing a predetermined amount of time. Therefore, occurrences where the different types of liquids rise over the partition wall portions 104 and become mixed such that color mixing occurs can be further reduced.

### Fourth Embodiment

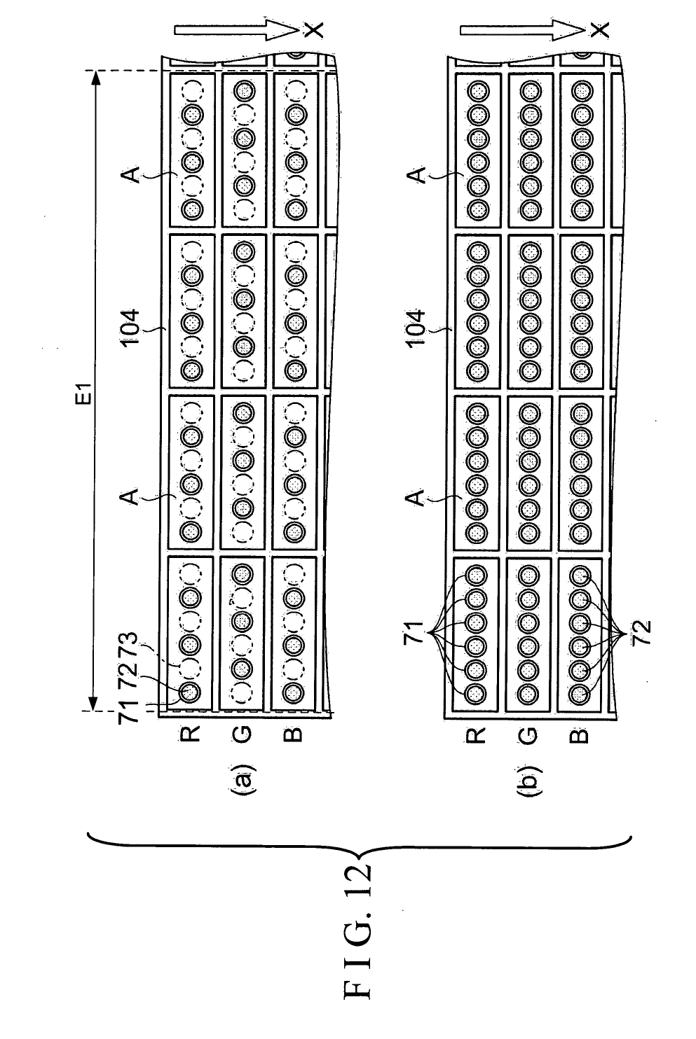

The diagrams (a) and (b) of FIG. 12 are schematic plan diagrams showing the ejected/drawn state of the liquids of the fourth embodiment. The fourth embodiment is one where, in the first drawing process, the plurality of liquids are caused to land and be drawn at intervals in the plurality of color element regions A included in the drawing region E, and in the second drawing process, the liquids are caused to land and be drawn in sites of the plurality of color element regions A where the liquids did not land in the first drawing process.

As shown in the diagram (a) of FIG. 12, in the first drawing process, the liquids 71 and 72 are caused to land and be drawn at intervals, by main scanning conducted at least two times, in the plurality of color element regions A where the color elements of the three types of red, green and blue in the drawing region E are to be formed. In this case also, as shown in the diagrams (a) and (b) of FIG. 8, the drawing region E is divided into the four partial drawing regions E1, E3, E5 and E7 and the remaining partial drawing regions E2, E4 and E6, and main scanning is repeated, whereby the liquids 71 and 72 are ejected and drawn. At this time, the liquids 71 and 72 are ejected such that the liquids 71 and 72 land shifted in the sub-scanning direction in the color element regions A where the different types of color elements are to be formed. Next, as shown in the diagram (b) of FIG. 12, in the second drawing process, the liquids 71 and 72 are caused to land and be re-ejected/redrawn in sites 73 of the plurality of color element regions A where the liquids 71 and 72 did not land in the first drawing process. Even during re-ejecting/redrawing, the drawing region E shown in the diagrams (a) and (b) of FIG. 8 is similarly divided into the four partial drawing regions E1, E3, E5 and E7 and the remaining partial drawing regions E2, E4 and E6, and main scanning is repeated, whereby the liquids 71 and 72 are ejected and drawn. In so doing, in the first drawing process, the liquids 71 and 72 land at intervals in a state where they are mutually shifted in the color element regions A where the different types of color elements are to be formed. Thus, occurrences where the liquids 71 and 72 that have risen in their landed positions rise over the partition wall portions 104 and become mixed together such that color mixing arises are reduced. Further, in the second drawing process, the liquids 71 and 72 land in the sites 73 in the plurality of color element regions A after a predetermined amount of time to divide the drawing region and conduct main scanning. Thus, natural drying of the liquids 71 and 72 that have landed previously proceeds such that the liquids 71 and 72 are further film-reduced, and the next liquids 71 and 72 land during that time, whereby color mixing is further reduced.

In the first to fourth embodiments explained above, the liquids 71 and 72 landed in the color element regions A in a state where they were lined in one row in the sub-scanning direction, but as shown in FIGS. 2A and 2B, because the liquid droplet ejection heads 52 actually include two nozzle rows 62, the liquids 71 and 72 may also be caused to land in two rows. Further, the number (amount) of liquid droplets landing in one color element region A may be changed depending on the size of the color element regions A and the types of the liquids.

### Electronic Device

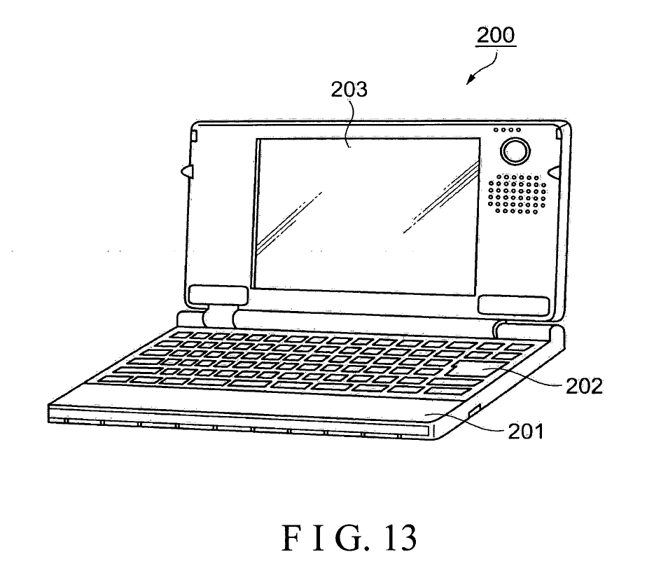

Next, an electronic device provided with the liquid crystal display device serving as the electro-optical device manufactured using the above-described liquid crystal display device manufacturing method will be described referring to FIG. 13. FIG. 13 is a schematic perspective diagram showing a portable information processing device 200 serving as the electronic device.

As shown in FIG. 13, the portable information processing device 200 serving as the electronic device of the present invention is provided with an information processing device body 201, which includes a keyboard 202 for input, and a display 203. The liquid crystal display device 100, in which color mixing of the color filters 105 is reduced and which has display quality that is highly attractive, is installed in the display 203.

The effects of the present invention are as follows.

(1) In the method of manufacturing the liquid crystal display device 100 of the present embodiment, in the first drawing process, first, the four partial drawing regions E1, E3, E5 and E7 of the seven partial drawing regions E1 to E7 resulting from the drawing region E on the substrate W being virtually divided are main-scanned at least two times, whereby the liquids 70R, 70G and 70B are ejected/drawn. Then, line feeding (sub-scanning) that causes the carriages 51 to move is conducted and the remaining partial drawing regions E2, E4 and E6 are similarly ejection-drawn. Thus, the first drawing layer 105a is formed. After the step of disposing a predetermined amount of time to eject/draw the remaining partial drawing regions E2, E4 and E6 by main scanning conducted at least two times, in the second drawing process, the four partial drawing regions E1, E3, E5 and E7 are redrawn by main scanning conducted at least two times. In one-time scanning in the first drawing process, the liquids 70R, 70G and 70B are ejected/drawn in an ejection amount where the total amount necessary in order to form the color filters 105 serving as color elements in the color element regions A has been divided, and in the second drawing process, the ejection amount is gradually reduced with respect to the first drawing process and the liquids are ejected/drawn. Consequently, in the first drawing process, occurrences where the liquids 70R, 70G and 70B rise over the partition wall portions 104 and become mixed together are reduced. Further, in the second drawing process, the liquids are again ejected/drawn after the predetermined amount of time and land after the liquids 70R, 70G and 70B that were ejected in the first drawing process have become film-reduced by natural drying during the predetermined amount of time. Thus, occurrences where the different types of liquids rise over the partition wall portions 104 and become mixed together are reduced. That is, color mixing of the color filters 105 can be reduced.

(2) In the method of forming the color elements of the second embodiment in the method of manufacturing the liquid crystal display device 100, in the second drawing process, one of divided regions resulting from each of the partial drawing regions E1, E3, E5 and E7 having been further virtually divided into two is drawn by main scanning. Thereafter, a predetermined amount of time is disposed to draw, by main scanning, one of divided regions resulting from each of the other partial drawing regions E2, E4 and E6 having been further virtually divided into two, and the remaining divided regions are drawn by main scanning conducted at least times. Consequently, the remaining partial drawing regions are redrawn in a state where natural drying of the liquid 71 that landed in the first drawing process further proceeds after a longer time. Thus, occurrences where the different types of liquids rise over the partition wall portions 104 and become mixed together are reduced, and color mixing of the color filters 105 is further reduced.

(3) In the method of forming the color elements of third embodiment in the method of manufacturing the liquid crystal display device 100, in the first drawing process, the liquids 71 and 72 are ejected and drawn in the color element regions A that are not adjacent to each other, and in the second drawing process, after disposing a predetermined amount of time to divide and main-scan the drawing region E, the liquids 71 and 72 land in the color element regions A where the liquids 71 and 72 did not land in the first drawing process. Consequently, because the liquids 71 and 72 land in one of the adjacent color element regions A, occurrences where the different types of liquids rise over the partition wall portions 104 and become mixed together such that color mixing arises are further reduced.

(4) In the method of forming the color elements of the fourth embodiment in the method of manufacturing the liquid crystal display device 100, in the first drawing process, the liquids 71 and 72 land at intervals in a state where they are mutually shifted in the color element regions A where the different types of color elements are to be formed. In the second drawing process, the liquids 71 and 72 again land such that they fill in the intervals after disposing a predetermined amount of time to divide and main-scan the drawing region E. Consequently, in a state where natural drying of the liquids 71 and 72 that have landed previously proceeds such that the liquids are film-reduced, the next liquids 71 and 72 land in the sites 73 during that time. Thus, occurrences where the different types of liquids rise over the partition wall portions 104 and become mixed together such that color mixing arise are further reduced.

(5) Because the portable information processing device 200 of the present embodiment is provided with the liquid crystal display device 100, the portable information processing device 200 can be provided which serves as an electronic device in which there are few display drawbacks such as color unevenness and with which information such as characters and images can be confirmed with high display quality.

### Modifications

Modifications other than the preceding embodiments are as follows.

(Modification 1) In the method of forming the color elements in the first embodiment to fourth embodiment, the drying of the liquid 71 (or the liquids 71 and 72) that has landed due to previous main scanning is not limited to natural drying. For example, the liquid droplet ejection apparatus 1 may be provided with a heater that can heat the substrate W, so that the liquid(s) are dried with the heater. Further, an air flow may be set such that it flows over the surface of the substrate W, and the liquid(s) may be dried with the air flow such that evaporation of the solvent from the liquid 71 is promoted.

(Modification 2) In the method of manufacturing the liquid crystal display device 100, with respect to the ejection amount of the liquids 70R, 70G and 70B ejected in the color element regions A by one-time main scanning, the amounts of single liquid droplets ejected from the nozzles 61 may be made the same, and the number of liquid droplets landing in the color element regions A may be changed between the first drawing process and the second drawing process. In so doing, the total amount can be divided and the liquids 70R, 70G and 70B can be ejected in the color element regions A without conducting complicated ejection control such as changing the sizes of the liquid droplets of the liquid 72 with respect to those of the liquid 71.

(Modification 3) In the liquid droplet ejection apparatus 1, the disposition of the liquid droplet ejection heads 52 mounted on the carriages 51 is not limited to this. For example, the liquid droplet ejection heads 52 that eject different types of liquids may also be disposed in parallel in the Y-axis direction such that they cover the same drawing range in the X-axis direction. By configuring the liquid droplet ejection apparatus 1 in this manner, the number of times that sub-scanning and main scanning are conducted can be reduced in consideration of the shift amount of the nozzle rows 62 of the liquid droplet ejection heads 52 that eject different types of liquids.

(Modification 4) In the liquid droplet ejection apparatus 1, the number of the carriages 51 is not limited to two. Further, the disposition of the liquid droplet ejection heads 52 mounted on the carriages 51 is not limited to this. For example, the liquid droplet ejection apparatus 1 may also be provided with just one of the carriages 51, and the liquid droplet ejection heads 52 may be disposed in the carriage 51 such that the interval between the nozzle rows 62 of the liquid droplet ejection heads 52 that eject the same type of liquid between the different head group rows of the head groups 52A and 52B and the head groups 52C and 52D becomes equal to (P2×320)×4+P2. That is, by using such a carriage 51, the drawing region E is ejection-drawn in a state where an interval two times the drawing width that the head groups (head group rows) arranged in the main scanning direction can draw is opened. Additionally, the liquid droplet ejection apparatus 1 may also be configured such that the drawing region E is ejection-drawn such that the drawing region E is divided into four (at least three) groups comprising the partial drawing regions E1 and E4, the partial drawing regions E2 and E5, the partial drawing regions E3 and E6, and the partial drawing region E7, and main scanning is repeated. By configuring the liquid droplet ejection apparatus 1 in this manner, in the first drawing process, the regions of the divided drawing region E can be line-fed one at a time and ejection-drawn, and in the second drawing process, the partial drawing regions E1 and E4 can be redrawn after disposing a predetermined amount of time to draw one at a time all of the other partial drawing regions other than the partial drawing regions E1 and E4, for example.

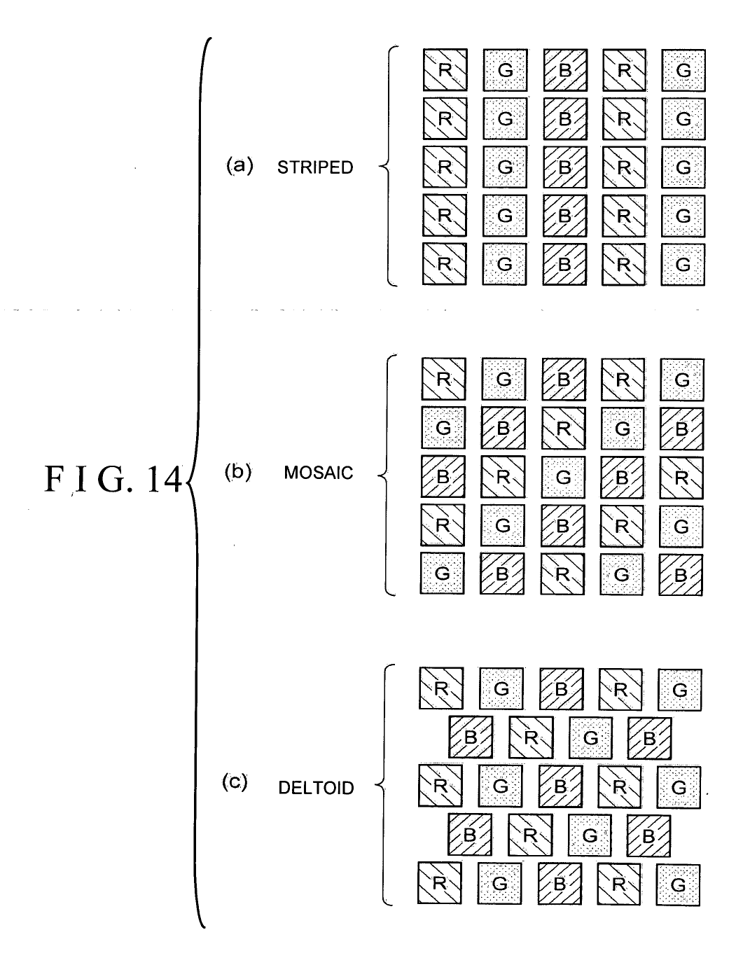

(Modification 5) The disposition of the color element regions A in the substrate W of the above-described embodiment is not limited to being striped. The diagrams (a) to (c) of FIG. 14 are schematic diagrams showing arrangements of the color element regions A. The arrangement of the color element regions A in the above-described embodiment was striped as shown in the diagram (a) of FIG. 14, but even with the mosaic arrangement shown in the diagram (b) of FIG. 14 or the deltoid arrangement shown in the diagram (c) of FIG. 14, the same color element forming method as in the above-described first to fourth embodiments can be applied and effects thereof are obtained.

(Modification 6) The method of forming the color filters 105 serving as color elements described in the first to fourth embodiments can also be applied to a case where transparent electrodes are formed in color element regions segmented by partition wall portions, a hole injection transport layer is layered on the formed transparent electrodes, a plurality of types of liquids including light-emitting layer forming material are ejected/drawn, and a light-emitting layer such as an organic EL layer is formed as the color elements.

(Modification 7) The electronic device provided with the liquid crystal display device 100 is not limited to the portable information processing device 200. For example, the liquid crystal display device 100 can be suitably used as image display means in mobile telephones, portable information devices and portable terminal devices called personal digital assistants (PDA), desktop computers, word processors, digital still cameras, in-car monitors, digital video cameras, liquid crystal televisions, viewfinder-type and monitor direct-diagram-type video tape recorders, car navigation systems, pagers, electronic notebooks, calculators, word processors, work stations, video phones, and POS terminals. Whatever the electronic device may be, display with good appearance can be conducted.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part”, “section”, “portion”, “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a liquid droplet ejection apparatus, a liquid crystal display device, or an electronic device equipped with the present invention. Accordingly, these terms, as utilized to describe the present invention should be interpreted relative to a liquid droplet ejection apparatus, a liquid crystal display device, or an electronic device equipped with the present invention as used in the normal riding position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A color element forming method comprising:
providing a liquid droplet ejection apparatus having a moving section configured and arranged to relatively move a plurality of liquid droplet ejection heads with respect to a substrate in a state where the liquid droplet ejection heads and the substrate are disposed facing each other;
ejecting a plurality of types of liquids including color element materials from nozzles of the liquid droplet ejection heads in a drawing region of the substrate including a plurality of color element regions segmented by a plurality of partition wall portions in synchronization with main scanning conducted for a plurality of times by the moving section to draw a plurality of types of color elements in the color element regions of the substrate;
hypothetically dividing the drawing region of the substrate into a plurality of partial drawing regions;
performing a first drawing process to draw at least one of the partial drawing regions with the main scanning conducted at least one time;
performing a second drawing process to redraw the at least one of the partial drawing regions drawn in the first drawing process by repeating the main scanning at least one time after a predetermined amount of time has elapsed since the first drawing process; and
ejecting the liquids in the main scanning during the first drawing process and the second drawing process with an ejection amount in which a total amount of the liquid required to form the color element in one of the color element regions has been divided.

2. The color element forming method as recited in claim 1, wherein
the performing of the second drawing process includes hypothetically dividing the at least one of the partial drawing regions into a plurality of sub regions, and repeating at least one time a process of drawing at least one of the sub regions with the main scanning and drawing a remaining of the sub regions with the main scanning after a predetermined time has elapsed since the previous main scanning of the at least one of the sub regions.

3. The color element forming method as recited in claim 1, further comprising
drawing one of the partial drawing regions other than the at least one of the partial drawing regions with the main scanning conducted at least one time between the first drawing process and the second drawing process to let the predetermined amount of time elapse after the first drawing process.

4. The color element forming method as recited in claim 1, further comprising
drawing the partial drawing regions other than the at least one of the partial drawing regions with the main scanning conducted at least two times between the first drawing process and the second drawing process to let the predetermined amount of time elapse after the first drawing process.

5. The color element forming method as recited in claim 1, wherein
the hypothetically dividing of the drawing region includes hypothetically dividing the drawing region into at least three partial drawing regions, and
drawing each of the partial drawing regions other than the at least one of the partial drawing regions with the main scanning conducted one time between the first drawing process and the second drawing process of the at least one of the partial drawing regions to let the predetermined amount of time elapse after the first drawing process of the at least one of the partial drawing regions.

6. The color element forming method as recited in claim 1, wherein
the performing of the second drawing process includes gradually reducing the ejection amount of the liquids ejected with the main scanning during the second drawing process in comparison to the first drawing process.

7. The color element forming method as recited in claim 1, wherein
the performing of the first drawing process includes ejecting the liquids in the color element regions that are not adjacent to each other in the at least one of the partial drawing regions,
the performing of the second drawing process includes ejecting the liquids in the color element regions where the liquids were not ejected during the first drawing process.

8. The color element forming method as recited in claim 1, wherein
the performing of the first drawing process includes ejecting a plurality of droplets of the liquids to land with intervals in the color element regions in the at least one partial drawing region, and
the performing of the second drawing process includes ejecting a plurality of droplets of the liquids to land in portions of the color element regions where the liquids did not land in the first drawing process.

9. A method of manufacturing an electro-optical device provided with an electro-optical panel that includes a pair of substrates with a plurality of color element regions segmented by partition wall portions disposed on at least one of the substrates, the method comprising:
drawing the plurality of types of the color elements by ejecting the plurality of types of the liquids including the color element materials on the color element regions in the at least one of the substrates in accordance with the color element forming method as recited in claim 1; and
drying the color elements formed on the at least one substrate to form films.

10. An electro-optical device with an electro-optical panel that includes a pair of substrates and the plurality of the color element regions segmented by the partition wall portions disposed on the at least one of the substrates, wherein
the color elements are formed in the color element regions on the at least one of the substrates in accordance with the method of manufacturing an electro-optical device as recited in claim 9.

11. An electronic device including the electro-optical device as recited in claim 10.

12. A liquid droplet ejection apparatus comprising:
a plurality of liquid droplet ejection heads;
a moving section configured and arranged to move the liquid droplet ejection heads with respect to a substrate in a state where the liquid droplet ejection heads and the substrate are disposed facing each other; and
a drawing control section configured to control the liquid droplet ejection heads and the moving section to eject a plurality of types of liquids including color element materials from nozzles of the liquid droplet ejection heads in a drawing region of the substrate including a plurality of color element regions segmented by a plurality of partition wall portions in synchronization with main scanning conducted for a plurality of times -by the moving section to draw a plurality of types of the color elements on the color element regions of the substrate,
the drawing control section being further configured to hypothetically divide the drawing region of the substrate into a plurality of partial drawing regions and to control the liquid droplet ejection heads and the moving section to perform a first drawing process to draw at least one of the partial drawing regions with the main scanning conducted at least one time and to perform a second drawing process to redraw the at least one of the partial drawing regions drawn in the first drawing process by repeating the main scanning at least one time after a predetermined amount of time has elapsed since the first drawing process,
the drawing control section being further configured to control the liquid droplet ejection heads to eject the liquids in the main scanning during the first drawing process and the second drawing process with an ejection amount in which a total amount of the liquids necessary in order to form the color element in one of the color element regions has been divided.
